(19) United States
(12) Patent Application Publication
(10) Pub. No.: US 2024/0075898 A1
(43) Pub. Date: Mar. 7, 2024

(54) AIRBAG

(71) Applicants: Hyundai Motor Company, Seoul (KR); Kia Corporation, Seoul (KR); Hyundai Mobis Co., Ltd., Seoul (KR)

(72) Inventors: Il Chang Sung, Hwaseong-si (KR); Byung Ho Min, Yongin-si (KR); Ju Kyung Kim, Yongin-si (KR)

(21) Appl. No.: 18/182,967

(22) Filed: Mar. 13, 2023

(30) Foreign Application Priority Data
Sep. 6, 2022 (KR) 1020220112861

(51) Int. Cl. B60R 21/20; B60R 21/2338

(52) U.S. Cl. CPC B60R 21/20; B60R 21/2338

(57) ABSTRACT

An airbag maintains deployment performance of an airbag cushion installed in a structure for dividing an occupant compartment space. The airbag includes an airbag cushion that includes a plurality of deployment areas and a spacing part that is disposed at a position adjacent to the plurality of deployment areas and separates the plurality of deployment area from one another.

### CROSS REFERENCE TO RELATED APPLICATION

The present application claims priority to Korean Patent Application No. 10-2022-0112861, filed on Sep. 6, 2022, the entire contents of which are incorporated herein for all purposes by reference.

### TECHNICAL FIELD

The present disclosure relates to an airbag capable of maintaining deployment performance of an airbag cushion even in case that a partition structure for dividing an occupant compartment space is installed.

### BACKGROUND

There has been developed a technology for structurally dividing an interior space to minimize a risk of infection between passengers in a vehicle in the event of a health crisis such as epidemic.

For example, a partition wall, which serves as a partition, may be installed in an occupant compartment and separate a front seat region and a rear seat region.

However, when a curtain airbag is deployed in a state in which the partition wall is installed on an inner surface of the occupant compartment, the cushion is caught by the partition wall, and the cushion cannot be properly deployed.

Accordingly, there is a need for a technology capable of maintaining deployment performance of a curtain airbag even in case that a partition wall in the form of a partition for dividing an occupant compartment space is installed.

### SUMMARY

The present disclosure describes an airbag capable of maintaining deployment performance of an airbag cushion even in case that a partition structure for dividing an occupant compartment space is installed.

According to one aspect of the subject matter described in this application, an airbag include an airbag cushion disposed adjacent to a plurality of deployment areas and having a spacing part defined by separating a part of the adjacent part.

Implementations according to this aspect can include one or more of the following features. For example, The airbag can include a partition member configured to divide a space in an occupant compartment into front and rear spaces, in which the deployment areas are respectively provided forward and rearward of the airbag cushion of the curtain airbag, and in which the spacing part is positioned on the partition member and deployed in a shape in which the deployment areas are separated forward and rearward of the partition member.

The partition member can be installed on the inner surface of the occupant compartment and divide the internal space into front and rear spaces. The deployment areas can be respectively provided forward and rearward of the airbag cushion of the curtain airbag, such that the spacing part between the front and rear deployment areas can be positioned on the partition member.

A portion between the deployment areas can be formed in the form of a cut-out slit, such that the deployment areas can be spaced apart from each other.

The deployment areas can be partially spaced apart from each other, and the remaining portion, except for the spacing part, can be formed to allow gas to flow between the deployment areas.

The spacing part can be formed at a lower end of the airbag cushion, and the gas can flow between the deployment areas at an upper side of the spacing part.

The airbag can further include a connection member configured to connect deployment areas provided at two opposite sides of the spacing part.

A length of the connection member can be determined depending on a thickness of the partition member.

A height of the connection member can be determined depending on a height of the spacing part.

Two opposite ends of the connection member can be respectively fixed to the two opposite deployment areas, and an intermediate portion of the connection member can be temporarily attached in the state in which the intermediate portion of the connection member overlaps one deployment area, such that a temporarily attached part is separated.

The intermediate portion of the connection member can be temporarily attached in a state in which the intermediate portion of the connection member overlaps several portions by changing a forward/rearward length of one deployment area, such that temporarily attached parts are selectively separated.

Two opposite ends of the connection member can be respectively fixed to the two opposite deployment areas, and the intermediate portion of the connection member can be temporarily attached in the state in which the intermediate portion of the connection member overlaps one deployment area, and the temporarily attached part may not be separated when the partition member is not provided.

A tether can be connected to be pulled in a direction in which the airbag cushion is deployed.

The tether can be connected between a vehicle body and an end of the deployment area.

In some implementations, the deployment areas formed on the airbag cushion are spaced apart from each other, and the partition wall is positioned in the spacing part. Therefore, it is possible to prevent a deterioration in deployment performance of the airbag cushion by preventing the airbag cushion from being jammed in the partition wall and interfering with the partition wall during a process in which the airbag cushion is filled with gas and inflated.

### BRIEF DESCRIPTION OF THE DRAWINGS

FIG. 1 is a view illustrating an example of a partition member installed in a vehicle.

FIG. 2 is a view illustrating an example of a curtain airbag in FIG. 1 that is deployed.

FIG. 3 is a view illustrating the curtain airbag deployed when viewed from the rear side.

FIG. 4 is a view illustrating the airbag cushion that is unfolded.

FIG. 5 is an enlarged view showing an example of a spacing part and an example of a connection member.

FIG. 6 is a view illustrating an example of the connection member that is folded.

FIG. 7 is a view illustrating another example of the connection member that is folded.

### DETAILED DESCRIPTION

Hereinafter, implementations disclosed in the present specification will be described in detail with reference to the accompanying drawings. The same or similar constituent elements are assigned with the same reference numerals regardless of reference numerals, and the repetitive description thereof will be omitted.

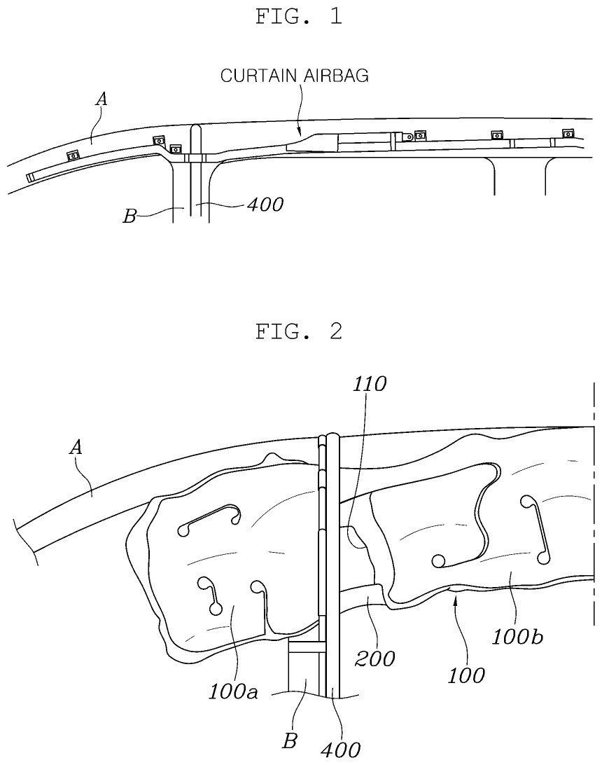

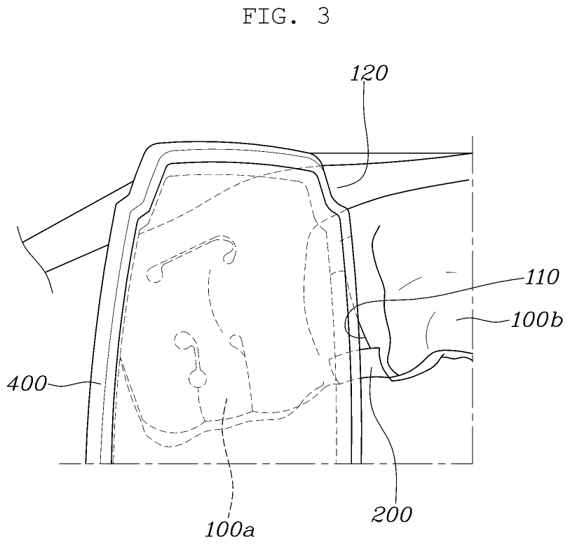

FIG. 1 is a view illustrating an example of a partition member 400 that is installed in a vehicle, and FIG. 2 is a view illustrating a state in which a curtain airbag in FIG. 1 is deployed.

In some implementations, an airbag includes an airbag cushion 100 having a plurality of deployment areas 100a and 100b disposed adjacent to one another, and a spacing part 110 is defined by separating a part of the adjacent portion.

In particular, the airbag includes a partition member 400 configured to divide a space in an occupant compartment. The airbag can be deployed in a shape in which the deployment areas 100a and 100b are separated in spaces partitioned by the spacing part 110 disposed between the deployment areas 100a and 100b and provided on the partition member 400.

For example, the partition member 400 serves as a partition wall 400 for dividing the space in the occupant compartment and is installed on an inner wall surface of the occupant compartment.

Therefore, when the partition wall 400 is installed in a deployment range of the airbag cushion 100 in case that the airbag is deployed, interference is caused by the partition wall 400 when the airbag cushion 100 is deployed, and the interference degrades the deployment performance of the airbag cushion 100.

In some examples, the partition wall 400 can be configured to be attachable and detachable. However, in case that a frame for installing the partition wall 400 is maintained without being detached, interference is caused by a frame when the airbag cushion 100 is deployed.

Therefore, in some implementations, the deployment areas 100a and 100b formed on the airbag cushion 100 are spaced apart from each other, the partition wall 400 is positioned in the spacing part 110.

Therefore, it is possible to prevent a deterioration in deployment performance of the airbag cushion 100 by preventing the interference caused by the partition wall 400 during a process in which the deployment areas 100a and 100b is filled with gas and inflated.

Further, in some implementations, the partition member 400 is installed on the inner surface of the occupant compartment and divides the internal space into front and rear spaces. The deployment areas 100a and 100b are respectively provided forward and rearward of the airbag cushion 100 of the curtain airbag, such that the spacing part 110 between the front and rear deployment areas 100a and 100b is positioned on the partition member 400.

For example, the partition member 400 is installed as a partition structure at a position of a B-pillar B of a vehicle and separates front and rear rows.

In some examples, the airbag cushion 100 can be included in the curtain airbag, where the airbag cushion 100 is installed on the B-pillar B on which the partition member 400 is positioned between the front and rear rows. For this reason, an intermediate portion of the airbag cushion 100 is jammed between the B-pillar B and the partition member 400 when the curtain airbag is deployed.

Therefore, in some implementations, the spacing part 110 is formed between the deployment areas 100a and 100b provided forward and rearward of the airbag cushion 100, and the partition wall 400 is positioned in the spacing part 110. Therefore, the intermediate portion of the airbag cushion 100 is deployed without interfering with the partition wall 400, which improves the deployment performance of the airbag cushion 100.

In some implementations, FIG. 4 is a view illustrating an example of the airbag cushion 100 that is unfolded.

Referring to the drawings, a portion between the deployment areas 100a and 100b is formed in the form of a cut-out slit, such that the deployment areas 100a and 100b are spaced apart from each other.

That is, because the front and rear deployment areas 100a and 100b are cut in the form of a slit, the partition wall 400 is positioned in the spacing part 110 as the portions of the slit 110 are separated and spaced apart from each other.

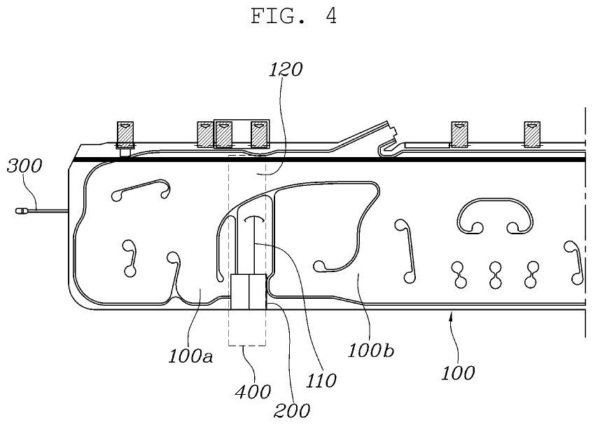

Further, referring to FIGS. 3 and 4, portions between the deployment areas 100a and 100b can be spaced apart from each other, and the remaining portions, except for the spacing part 110, can be formed so that gas flows between the deployment areas 100a and 100b.

Particularly, the spacing part 110 can be formed at a lower end of the airbag cushion 100. The gas flows between the deployment areas 100a and 100b at an upper side of the spacing part 110.

That is, the slit 110 is formed at a lower end of upper and lower length sections of the airbag cushion 100 in which the partition wall 400 is positioned. A gas passageway 120 is formed at an upper end of the upper and lower length sections of the airbag cushion 100 and connects the front deployment area 100a and the rear deployment area 100b.

Therefore, when the gas provided from an inflator is injected into the rear deployment area 100b, the airbag cushion 100 is deployed as the front deployment area 100a is filled with the gas passing through the gas passageway 120 while pushing a head lining and the partition wall 400 by a flow and pressure of the gas with which the rear deployment area 100b is filled.

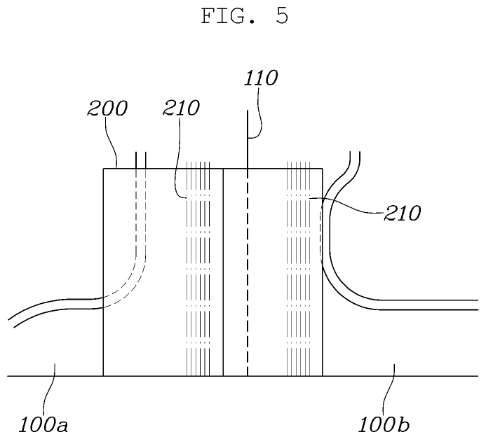

In some implementations, FIG. 5 is an enlarged view of an example of the spacing part 110 and an example of a connection member 200.

Referring to the drawings, the airbag further includes the connection member 200 configured to connect the spacing part 110.

For example, the connection member 200 can be a patch having a band shape. The connection member 200 is fixed between the front deployment area 100a and the rear deployment area 100b while covering the slit 110.

Therefore, in case that a passenger's head is loaded onto the rear deployment area 100b in the event of a broadside collision or a rollover accident of the vehicle, the connection member 200 fixed to the front deployment area 100a holds the rear deployment area 100b.

Therefore, the rear deployment area 100b is prevented from being separated to the outside of a window. Therefore, it is possible to restrain the passenger's head and safely protect the passenger from an accident of the vehicle.

Further, a length of the connection member 200 can be determined depending on a thickness of the partition member 400.

That is, a forward/rearward length of the patch 200 can be increased when the thickness of the partition wall 400 is large, and the forward/rearward length of the patch 200 can be decreased when the thickness of the partition wall 400 is small.

Therefore, a height of the connection member 200 can be determined depending on a height of the spacing part 110.

That is, because a height of the patch 200 can be determined depending on a height of the slit 110, the amount of opening of the slit 110 can be controlled and the rigidity of the slit 110 can be adjusted by adjusting the height of the patch 200.

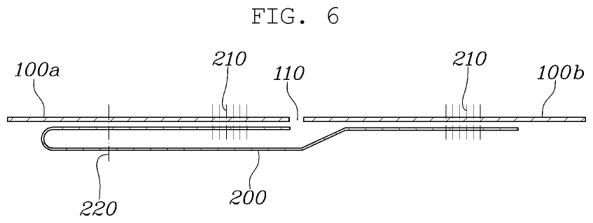

FIG. 6 is a view illustrating an example of the connection member 200 that is folded.

Referring to FIG. 6, two opposite ends of the connection member 200 are respectively fixed to the two opposite deployment areas 100a and 100b, and an intermediate portion of the connection member 200 is temporarily attached in the state in which the intermediate portion of the connection member 200 overlaps one deployment area, such that a temporarily attached part 220 can be separated.

Specifically, a front end of the patch 200 is sewed to the front deployment area 100a adjacent to the slit 110 to define a fixing part 210, and a rear end of the patch 200 is sewed to the rear deployment area 100b adjacent to the slit 110 to define a fixing part 210.

This is to fix the patch 200 to the airbag cushion 100 by using the sewed fixing part 210 so that the patch 200 does not separate from the front and rear deployment areas 100a and 100b when the airbag cushion 100 is deployed, such that the slit 110 is prevented from being excessively opened.

In contrast, the temporarily attached part 220 sewed to the intermediate portion of the patch 200 serves to temporarily fix an extra portion of the forward/rearward length of the patch 200. When the airbag cushion 100 is deployed, the temporarily attached part 220 is torn and separated from the front deployment area 100a, thereby increasing the amount of opening of the slit 110.

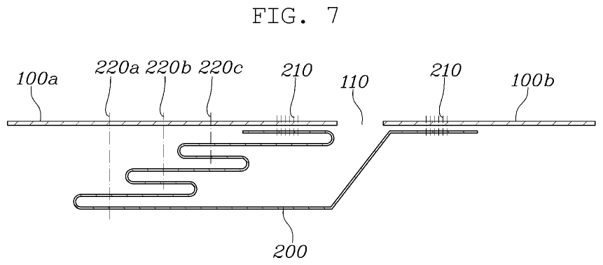

FIG. 7 is a view illustrating another example of the connection member 200 that is folded.

For example, referring to FIG. 7, the intermediate portion of the connection member 200 is temporarily attached in a state in which the intermediate portion of the connection member 200 overlaps several portions by changing the forward/rearward length of one deployment area, such that temporarily attached parts 220a, 220b, and 220c can be selectively separated.

Particularly, the temporarily attached parts 220a, 220b, and 220c to be separated are changed depending on the thickness of the partition wall 400, such that the forward/rearward length of the connection member 200 is adjusted, and the amount of opening of the slit 110 is adjusted.

For example, in case that the thickness of the partition wall 400 is 10 mm, the amount of opening of the slit 110 is relatively small, such that only the first temporarily attached part 220a is torn and separated by a distance by which the slit 110 is opened.

Further, in case that the thickness of the partition wall 400 is 20 mm, the amount of opening of the slit 110 increases in comparison with the partition wall 400 having a thickness of the 10 mm. Therefore, the first temporarily attached part 220a and the second temporarily attached part 220b are torn and separated by the distance by which the slit 110 is opened.

In addition, in case that the thickness of the partition wall 400 is 30 mm, the amount of opening of the slit 110 increases in comparison with the partition wall 400 having a thickness of 20 mm, all the first, second, and third temporarily attached parts 220a, 220b, and 220c are torn and separated by the distance by which the slit 110 is opened.

As described above, because the temporarily attached parts 220a, 220b, and 220c to be torn are changed depending on the thickness of the partition wall 400, the forward/rearward length of the patch 200 is formed to be suitable for the amount of opening of the slit 110.

However, in some implementations, the two opposite ends of the connection member 200 are respectively fixed to the two opposite deployment areas 100a and 100b, and the intermediate portion of the connection member 200 is temporarily attached in the state in which the intermediate portion of the connection member 200 overlaps one deployment area. In this case, the temporarily attached part 220 may not be separated when the partition member 400 is not provided.

That is, in a case, where the installation of the partition wall 400 is not provided, the temporarily attached part 220 can be securely fixed, such that the temporarily attached part 220 is not torn.

Therefore, in case that a passenger's head is loaded onto the rear deployment area 100b in the event of a broadside collision or a rollover accident of the vehicle, the temporarily attached part 220 is kept fixed without being torn, such that the connection member 200 fixed to the front deployment area 100a holds the rear deployment area 100b.

Therefore, the rear deployment area 100b is prevented from being separated to the outside of the window. Therefore, it is possible to restrain the passenger's head and safely protect the passenger from an accident of the vehicle.

In some examples, where the front and rear deployment areas are connected by the connection member 200 without the temporarily attached part 220, the structure prevents the opening of the spacing part 110 regardless of the presence or absence of the partition member 400, such that the airbag can safely perform the inherent function of the curtain airbag.

In some implementations, referring to FIG. 4, a tether 300 can be connected and pulled in the direction in which the airbag cushion 100 is deployed.

Specifically, the tether 300 can be connected between a vehicle body and ends of the deployment areas 100a and 100b.

For example, a rear end of the tether 300 is connected to a front end of the front deployment area 100a, and a front end of the tether 300 is connected to a part of the A-pillar A.

That is, even though jamming is caused by the partition wall 400 when the airbag cushion 100 is deployed, a force for pulling the airbag cushion 100 is provided by the tether 300 in the direction in which the airbag cushion 100 is deployed.

Therefore, a portion of the airbag cushion 100 jammed by the partition wall 400 is quickly separated from the partition wall 400 and deployed, which improves the deployment performance of the airbag cushion 100.

In some examples, the tether 300 can be configured to increase a length thereof depending on a change in force for pulling the tether 300. Therefore, even though the position of the airbag cushion 100 to which the tether 300 is connected changes, the length of the tether 300 can be changed, which makes it possible to pull the airbag cushion 100 in the direction in which the airbag cushion 100 is deployed.

In some implementations, the deployment areas 100a and 100b formed on the airbag cushion 100 are spaced apart from each other, and the partition wall 400 is provided in the spacing part 110. Therefore, it is possible to prevent a deterioration in deployment performance of the airbag cushion 100 by preventing the airbag cushion 100 from being jammed in the partition wall 400 and interfering with the partition wall 400 during a process in which the airbag cushion 100 is filled with gas and inflated.

While the present disclosure has been described with reference to the specific examples, it is apparent to those skilled in the art that various modifications and alterations can be made within the technical spirit of the present disclosure, and these modifications and alterations belong to the appended claims.

What is claimed is:

1. An airbag of a vehicle, comprising:
an airbag cushion comprising a plurality of deployment areas; and
a spacing part that is defined at a position adjacent to the plurality of deployment areas and separates the plurality of deployment areas from one another.

2. The airbag of claim 1, further comprising:
a partition member configured to be disposed at a part of the vehicle that divides an occupant compartment of the vehicle into front and rear spaces,
wherein the plurality of deployment areas are disposed at a forward portion and a rearward portion of the airbag cushion, respectively, and
wherein the spacing part is defined at a position corresponding to the partition member and separates the plurality of deployment areas into the forward portion and the rearward portion with respect to the partition member.

3. The airbag of claim 2, wherein the spacing part has a cut-out slit shape and defines an opening.

4. The airbag of claim 2, wherein the plurality of deployment areas comprise:
first portions that are spaced apart from each other; and
second portions that are in fluid communication with each other to thereby allow gas to flow between the plurality of deployment areas.

5. The airbag of claim 4, wherein the spacing part is defined at a lower end of the airbag cushion, and
wherein the plurality of deployment areas are configured to allow the gas to flow therebetween through an upper side of the spacing part.

6. The airbag of claim 2, further comprising:
a connection member that connects the plurality of deployment areas disposed at two opposite sides of the spacing part.

7. The airbag of claim 6, wherein a length of the connection member is determined based on a thickness of the partition member.

8. The airbag of claim 6, wherein a height of the connection member is determined based on a height of the spacing part.

9. The airbag of claim 8, wherein two opposite ends of the connection member are respectively fixed to the plurality of deployment areas disposed at the two opposite sides of the spacing part, and
wherein the connection member comprises an intermediate portion that overlaps with and is attached to one deployment area among the plurality of deployment areas, the intermediate portion being configured to be separated from the one deployment area.

10. The airbag of claim 9, wherein the intermediate portion of the connection member overlaps with a plural portions of the one deployment area and is configured to change a forward/rearward length of the one deployment area, the intermediate portion of the connection member being configured to be selectively separated from the plural portions of the one deployment area.

11. The airbag of claim 1, further comprising:
a connection member that connects the plurality of deployment areas disposed at two opposite sides of the spacing part.

12. The airbag of claim 11, wherein two opposite ends of the connection member are respectively fixed to the plurality of deployment areas disposed at the two opposite sides of the spacing part, and
wherein the connection member comprises an intermediate portion that overlaps with and is attached to one deployment area among the plurality of deployment areas, the intermediate portion being configured to remain attached to the one deployment area.

13. The airbag of claim 2, further comprises a tether connected to the airbag cushion and configured to be pulled in a deployment direction of the airbag cushion.

14. The airbag of claim 13, wherein the tether is configured to be connected between a vehicle body and an end of the plurality of deployment areas.
